(19) United States
(12) Patent Application Publication
(10) Pub. No.: US 2006/0276189 A1
(43) Pub. Date: Dec. 7, 2006

(54) Supporting inter-technology handover using IEEE 802.16 handover procedures

(75) Inventors: Brian Gregory Kiernan, Downingtown, PA (US); Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/393,305

(22) Filed: Mar. 29, 2006

Related U.S. Application Data
(60) Provisional application No. 60/667,450, filed on Apr. 1, 2005.

(51) Int. Cl. H04Q 7/20

(52) U.S. Cl. 455/436; 455/502

(57) ABSTRACT

A method for performing an inter-technology handover in a wireless communication system in which a mobile subscriber station (MSS) changes base stations (BS) begins by locating one or more target BSs that the MSS can handover to. The technology used by each target BS is identified, and the technology supported by the MSS is determined. A handover of the MSS is performed to a target BS with which the MSS can communicate.

### CROSS REFERENCE TO RELATED APPLICATION

This application claims the benefit of U.S. Provisional Application No. 60/667,450 filed Apr. 1, 2005, which is incorporated by reference as if fully set forth herein.

### FIELD OF INVENTION

The present invention generally relates to handover procedures, and more particularly, to supporting an inter-technology handover using 802.16 handover procedures.

### BACKGROUND

The current specifications in IEEE 802.16 (WIMAX) include support for mobility of mobile subscriber stations (MSS) between base stations (BS) that operate according to IEEE 802.16. With the evolution of wireless/mobile technology and the co-existence of a plurality of WLAN technologies (such as IEEE 802.11b, 802.11g, 802.11n, 802.16, 802.20, GSM, GPRS, CDMA2000, UMTS, etc.), there is a need for supporting the mobility between BSs that operate according to different technologies. The existing IEEE 802.16 specification provides a foundation for this objective, but most of the messages defined in the specification lack fields that define the technology which the BSs and MSSs are using for communications. Additional modifications to the existing message formats are required in order for a multi-mode terminal to be able to understand the various technologies available as a target for handover.

Some of the 802.16 basic operations include: a BS sending a list of neighboring BSs (via a neighbor advertisement (MOB_NBR-ADV) message); inter-BS communication; MSS scanning and monitoring for neighbor BSs; MSS reporting power measurements to a BS; MSS initiated cell reselection; BS initiated handover; network manager initiated handover; make before break handover; break before make handover; MSS/BS notification of handover; MSS/BS listing of target BSs; and ping-pong effect (via a MSS_PINGPONG_REPORT message).

### SUMMARY

The present invention expands existing procedures and message formats in order to support inter-technology handover (i.e., IEEE 802.16 to/from IEEE 802.11, IEEE 802.16 to/from GSM, IEEE 802.11 to GPRS, IEEE 802.16 to/from UMTS, etc.). Specifically, a new field is proposed in the handover related messages. The new field identifies the neighbor BS standard specification (technology). The new field can be either a new type-length-value (TLV) encoded neighbor information record or a new field in the existing messages (e.g., MOB_NBR-ADV, MSS_NBR-RSP, MOB_SCAN-REPORT, MOB_BSHO-REQ, MOB_MSSHO-REQ, MOB_BSHO-RSP, etc.).

A method for performing an inter-technology handover in a wireless communication system in which a mobile subscriber station (MSS) changes base stations (BS) begins by locating one or more target BSs that the MSS can handover to. The technology used by each target BS is identified, and the technology supported by the MSS is determined. A handover of the MSS is performed to a target BS with which the MSS can communicate.

A method for performing an inter-technology handover in a wireless communication system having a MSS, a serving BS, and one or more target BSs begins by sending a neighbor advertisement message from the serving BS to the MSS. The neighbor advertisement message identifies the one or more target BSs and an operational technology for each BS. A list of candidate BSs is identified, the candidate BSs selected from the one or more target BSs. The MSS is synchronized to each of the candidate BSs to determine a signal quality from each BS. A preferred BS for handover is determined and a handover to the preferred BS is performed.

Several modified messages are disclosed, including a neighbor advertisement message, a neighbor report message, a BS initiated handover request message, a MSS initiated handover request message, a BS handover response message, and a handover indication message. Each of these messages is based on an existing message type and includes an operational technology field for identifying the operational technology of a neighbor BS. For example, this field can include whether the neighbor BS utilizes 802.11 or 802.16 technology.

A MSS configured to perform an inter-technology handover from a serving BS using a first operational technology to a target BS using a second operational technology includes a transmitter/receiver, a processor, a first operational technology part, and a second operational technology part. The processor is in communication with the transmitter/receiver and includes a technology type determining device. The first operational technology part is in communication with the technology type determining device. The second operational technology part is in communication with the technology type determining device and is configured to use a different operating technology than the first operational technology part. The technology type determining device is configured to receive messages from the serving BS and the target BS and to pass the messages to the appropriate operational technology part.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1A is a flow diagram of an existing cell reselection procedure;

FIG. 1B is a flow diagram of a cell reselection procedure showing an inter-technology cell reselection;

FIG. 2A is a flow diagram of an existing MSS initiated handover procedure;

FIG. 2B is a flow diagram of an inter-technology MSS initiated handover procedure;

FIG. 3A is a flow diagram of an existing BS initiated handover procedure;

FIG. 3B is a flow diagram of an inter-technology BS initiated handover procedure;

FIG. 4A is a diagram of an existing neighbor advertisement message;

FIG. 4B is a diagram of a neighbor advertisement message including operational technology information;

FIG. 5A is a diagram of an existing MSS neighbor report message;

FIG. 5B is a diagram of a MSS neighbor report message including operational technology information;

FIG. 6A is a diagram of an existing BS handover request message;

FIG. 6B is a diagram of a BS handover request message including operational technology information;

FIG. 7A is a diagram of an existing MSS handover request message;

FIG. 7B is a diagram of a MSS handover request message including operational technology information;

FIG. 8A is a diagram of an existing BS handover response message;

FIG. 8B is a diagram of a BS handover response message including operational technology information;

FIG. 9A is a diagram of an existing handover indication message;

FIG. 9B is a diagram of a handover indication message including operational technology information; and

FIG. 10 is a block diagram of a system configured to utilize the operational technology information field.

### DETAILED DESCRIPTION OF THE PREFERRED EMBODIMENTS

Hereafter, the term “mobile subscriber station” (MSS) includes, but is not limited to, a station (STA), a wireless transmit/receive unit (WTRU), a user equipment, a fixed or mobile subscriber unit, a pager, or any other type of device capable of operating in a wireless environment. When referred to hereafter, the term “base station” (BS) includes, but is not limited to, an access point (AP), a Node B, a site controller, or any other type of interfacing device in a wireless environment.

Cell Reselection

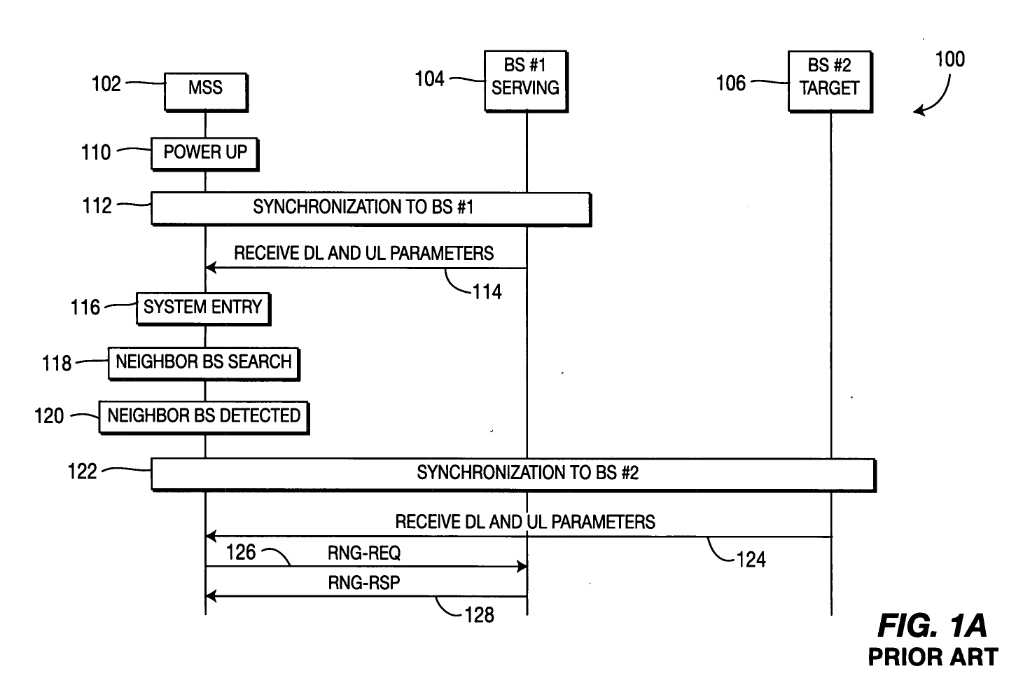

FIG. 1A is a flow diagram of an existing 802.16 cell reselection procedure 100. The procedure 100 utilizes an MSS 102, a serving BS (BS #1) 104, and a target BS (BS #2) 106. The MSS 102 powers up (step 110) and synchronizes to the serving BS 104 (step 112). The MSS 102 receives downlink (DL) and uplink (UL) parameters from the serving BS 104 (step 114). The MSS 102 enters the system (step 116), performs a neighbor BS search (step 118), and detects a neighbor BS (step 120), which in the example shown in FIG. 1A is the target BS 106.

The MSS 102 synchronizes to the target BS 106 (step 122) and receives DL and UL parameters from the target BS 106 (step 124). The MSS 102 sends a ranging request (RNG-REQ) message to the serving BS 104 to perform initial power leveling and ranging (step 126). The serving BS 104 responds with a ranging response (RNG-RSP) message including information about the MSS's transmit time advance and power adjustments (step 128).

FIG. 1B is a flow diagram of a cell reselection procedure 150 showing an inter-technology cell reselection. The procedure 150 utilizes an MSS 152 having an 802.11 part 154 and an 802.16 part 156, a serving BS (BS #1) 158 that operates under 802.16, and a target BS (BS #2) 160 that operates under 802.11. The MSS 152 powers up (step 162) and synchronizes to the serving BS 158 using 802.16 technology (step 164). The MSS 152 receives 802.16 DL and UL parameters from the serving BS 104 (step 166). The MSS 152 enters the 802.16 system (step 168), performs a neighbor BS search (step 170) and detects a neighbor BS (step 172), which in the example shown in FIG. 1B is the target BS 160.

The MSS 152 synchronizes to the target BS 160 using 802.11 technology and the 802.11 part 154 (step 174) and receives 802.11 DL and UL parameters from the target BS 160 (step 176). The MSS 152 sends a ranging request (RNG-REQ) message to the serving BS 158 to perform initial power leveling and ranging (step 178). The serving BS 158 responds with a ranging response (RNG-RSP) message including information about the MSS's transmit time advance and power adjustments (step 180).

It is noted that the procedure 150 will operate in generally the same manner if the serving BS 158 uses 802.11 technology and the target BS 160 uses 802.16 technology.

MSS Initiated Handover

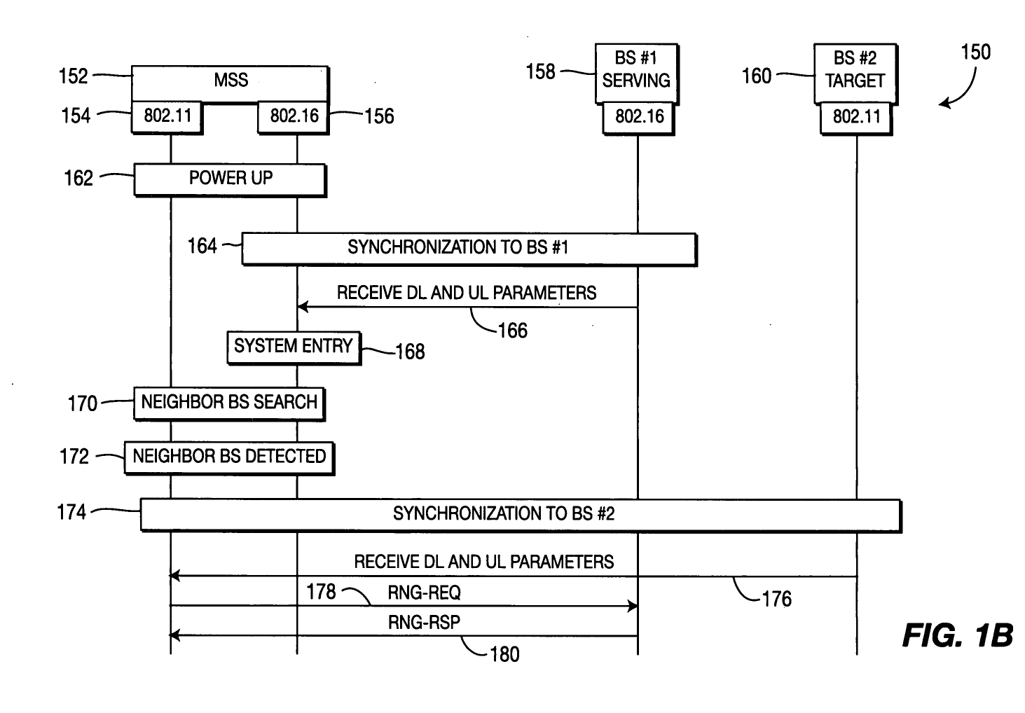

FIG. 2A is a flow diagram of an existing 802.16 MSS initiated handover procedure 200. The procedure 200 utilizes an MSS 202, a serving BS (BS #1) 204, a first target BS (BS #2) 206, and a second target BS (BS #3) 208. The serving BS 204 sends a neighbor advertisement (MOB_NBR-ADV) message to the MSS 202 (step 210). The neighbor advertisement message is used to identify the network and define the characteristics of the neighbor BSs to a potential MSS seeking initial network entry or handover. In the example shown in FIG. 2A, the neighbor advertisement message indicates that there are two neighbor BSs.

The MSS 202 sends a scanning interval allocation request (MOB_SCN-REQ) message to the serving BS 204 (step 212). The scanning interval allocation request message is sent by the MSS 202 to request a scanning interval (including the duration N of the requested scanning period) for the purpose of seeking available BSs and determining their suitability as targets for handover. The serving BS 204 responds to the scanning interval allocation request with a scanning interval allocation response (MOB_SCN-RSP) message, which includes information on when the scan is to begin (in M frames; step 214). After M frames have passed, the MSS 202 begins the neighbor BS search (step 216). Over a period of N frames (as requested in the MOB_SCN-REQ message), the MSS 202 synchronizes to the first target BS 206 and makes signal level, interference level, and noise level measurements (step 218) and the MSS 202 synchronizes to the second target BS 208 and makes signal level, interference level, and noise level measurements (step 220).

When the MSS 202 wants to initiate a handover, it sends a handover request (MOB_MSSHO-REQ) message to the serving BS 204 (step 222). The handover request message can include a report metric regarding the candidate BSs; in the example shown on FIG. 2A, the report metric is the carrier to interference plus noise ratio (CINR) value for each BS. The serving BS 204 sends a handover pre-notification message to both target BSs 206, 208 (steps 224, 226). The pre-notification message includes information about the MSS 202, such as the MSS ID, connection parameters, MSS capabilities, bandwidth (BW), and a desired quality of service (QoS).

The first target BS 206 sends a handover pre-notification response message to the serving BS 204 (step 228). The pre-notification response includes an acknowledgement (ACK) that the pre-notification message was received, the QoS level that the target BS is able to provide, identification information for the target BS, and some overhead fields. The second target BS 208 also sends a handover pre-notification response message to the serving BS 204 (step 230). It is noted that the messages sent in steps 228 and 230 can be reversed in order. In the example shown in FIG. 2A, the first target BS 206 can only provide a lower QoS than requested by the MSS, whereas the second target BS 208 can provide the requested QoS level.

Upon receipt of the pre-notification response messages, the serving BS 204 determines which target BS is better able to serve the MSS 202 by evaluating the capabilities of each target BS against the parameters requested by the MSS 202. As shown in FIG. 2A, the second target BS 208 is selected because it is able to provide the requested QoS level. The serving BS 204 sends a handover confirmation message to the second target BS 208 (step 232). The serving BS 204 also sends a handover response (MOB_HO-RSP) message to the MSS 202 indicating that the handover will be to the second target BS 208 (step 234). It is noted that steps 232 and 234 can be reversed in order without altering the overall performance of the procedure 200.

The MSS 202 sends a handover indication (MOB_HO-IND) message to the serving BS 204 as a final indication that it is about to perform a handover (step 236). If the MSS 202 is going to cancel or reject the handover, the handover indication message will inform the serving BS 204. The handover indication message includes a time parameter (L frames) after which the MSS 202 will initiate the handover. The MSS 202 synchronizes to the second target BS 208 (step 238) and sends a ranging request (RNG-REQ) message to the second target BS 208 to perform initial power leveling and ranging (step 240). The second target BS 208 responds with a ranging response (RNG-RSP) message including information about the MSS's transmit time advance and power adjustments (step 242).

FIG. 2B is a flow diagram of an inter-technology MSS initiated handover procedure 250. The procedure 250 utilizes an MSS 252 having an 802.11 part 254 and an 802.16 part 256, a serving BS (BS #1) 258 using 802.16 technology, a first target BS (BS #2) 260 using 802.16 technology, and a second target BS (BS #3) 262 using 802.11 technology. The serving BS 258 sends a neighbor advertisement (MOB_NBR-ADV) message to the 802.16 part 256 of the MSS 252 (step 264). The neighbor advertisement message is used to identify the network and define the characteristics of the neighbor BSs to a potential MSS seeking initial network entry or handover. The neighbor advertisement message includes the technology types for each target BS. In the example shown in FIG. 2B, the neighbor advertisement message indicates that there are two neighbor BSs, one using 802.16 technology and the other using 802.11 technology. The MSS also keeps track of the technology type used by each potential target BS.

The MSS 252 sends a scanning interval allocation request (MOB_SCN-REQ) message to the serving BS 258 (step 266). The scanning interval allocation request message is sent by the MSS 252 to request a scanning interval (including the duration N of the requested scanning period) for the purpose of seeking available BSs and determining their suitability as targets for handover. The serving BS 258 responds to the scanning interval allocation request with a scanning interval allocation response (MOB_SCN-RSP) message, which includes information on when the scan is to begin (in M frames; step 268). After M frames have passed, the MSS 252 begins the neighbor BS search (step 270). Over a period of N frames (as requested in the MOB_SCN-REQ message), the MSS 252 synchronizes to the first target BS 260 and makes signal level, interference level, and noise level measurements (step 272) and the MSS 252 synchronizes to the second target BS 262 and makes signal level, interference level, and noise level measurements (step 274).

When the MSS 252 wants to initiate a handover, it sends a handover request (MOB_MSSHO-REQ) message to the serving BS 258 (step 276). It is noted that the MSS can request a preferred technology type for the handover, if for example, there is more than one target BS operating with two different technologies and providing the same signal strength. However, from a deployment point of view, it is generally easier to perform a handover within the same technology, since changing operating technologies creates a risk of losing data due to the relatively long time required to change operating technologies.

The handover request message can include a report metric regarding the candidate BSs; in the example shown on FIG. 2B, the report metric is the CINR value for each BS. The serving BS 258 sends a handover pre-notification message to both target BSs 260, 262 (steps 278, 280). The pre-notification message includes information about the MSS 252, such as the MSS ID, connection parameters, MSS capabilities, BW, and a desired QoS.

The first target BS 260 sends a handover pre-notification response message to the serving BS 258 (step 282). The pre-notification response includes an ACK that the pre-notification message was received and the QoS that the target BS is able to provide. The second target BS 262 also sends a handover pre-notification response message to the serving BS 258 (step 284). It is noted that the messages sent in steps 282 and 284 can be reversed in order. In the example shown in FIG. 2B, the first target BS 260 can only provide a lower QoS than requested by the MSS, whereas the second target BS 262 can provide the requested QoS level.

Upon receipt of the pre-notification response messages, the serving BS 258 determines which target BS is better able to serve the MSS 252 by evaluating the capabilities of each target BS against the parameters requested by the MSS 252. As shown in FIG. 2B, the second target BS 262 is selected because it is able to provide the requested QoS level. The serving BS 258 sends a handover confirmation message to the second target BS 262 (step 286). The serving BS 258 also sends a handover response (MOB_HO_RSP) message to the MSS 252 indicating that the handover will be to the second target BS 262 (step 288). It is noted that steps 286 and 288 can be reversed in order without altering the overall performance of the procedure 250.

The MSS 252 sends a handover indication (MOB_HO-IND) message to the serving BS 258 as a final indication that it is about to perform a handover (step 290). If the MSS 252 is going to cancel or reject the handover, the handover indication message will inform the serving BS 258. The handover indication message includes a time parameter (L frames) after which the MSS 252 will initiate the handover. The MSS 252 synchronizes to the second target BS 262 using 802.11 technology (step 292), sends a ranging request (RNG-REQ) message to the second target BS 262 to perform initial power leveling and ranging (step 294). The second target BS 262 responds with a ranging response (RNG-RSP) message including information about the MSS's transmit time advance and power adjustments (step 296).

BS Initiated Handover

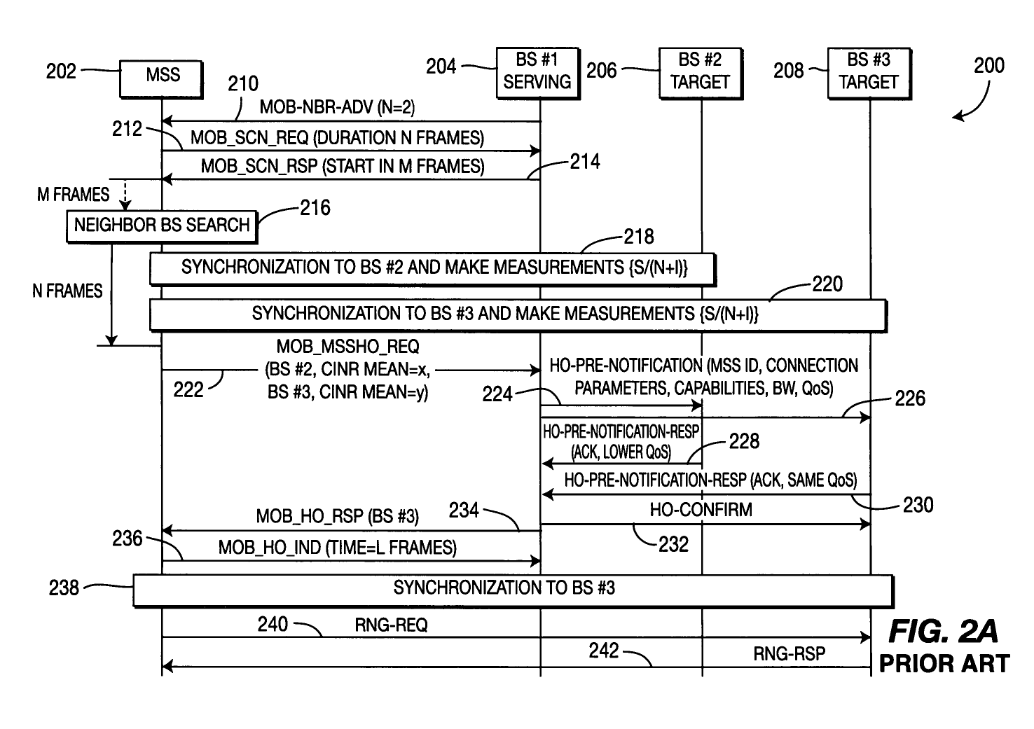

FIG. 3A is a flow diagram of an existing 802.16 BS initiated handover procedure 300. The procedure 300 utilizes an MSS 302, a serving BS (BS #1) 04, a first target BS (BS #2) 306, and a second target BS (BS #3) 308. The serving BS 304 sends a neighbor advertisement (MOB_NBR-ADV) message to the MSS 302 (step 310). The neighbor advertisement message is used to identify the network and define the characteristics of the neighbor BSs to a potential MSS seeking initial network entry or handover. In the example shown in FIG. 3A, the neighbor advertisement message indicates that there are two neighbor BSs.

The serving BS 304 initiates the handover (step 312) and sends a handover pre-notification message to both target BSs 306, 308 (steps 314, 316). The pre-notification message includes information about the MSS 302, such as the MSS ID, connection parameters, MSS capabilities, BW, and a desired QoS. The serving BS 304 then sends a handover request (MOB_BSHO-REQ) message to the MSS 302 (step 318). The handover request message includes a list of recommended BSs for the MSS 302 to examine. In FIG. 3A, the handover request message indicates that BS #2 and BS #3 are on the list of recommended BSs.

The MSS 302 initiates a neighbor BS search (step 320), examining each of the BSs recommended by the serving BS 304. While the MSS 302 is performing the neighbor BS search, the serving BS 304 receives handover pre-notification response messages from the first target BS 306 and the second target BS 308 (steps 322, 324). The pre-notification response includes an ACK that the pre-notification message was received and the QoS that the target BS is able to provide. The MSS 302 synchronizes to the first target BS 306 and makes signal level, interference level, and noise level measurements (step 326) and the MSS 302 synchronizes to the second target BS 308 and makes signal level, interference level, and noise level measurements (step 328).

After completing the measurements of the target BSs, the MSS 302 sends a handover response (MOB_MSSHO-RSP) message to the serving BS 304, including CINR values for each target BS (step 330). The serving BS 304 determines which target BS is better able to serve the MSS 302 by evaluating the capabilities of each target BS against the parameters in the handover pre-notification message. As shown in FIG. 3A, the second target BS 308 is selected because it is able to provide the requested QoS level. The serving BS 304 sends a handover response (MOB_HO-RSP) message to the MSS 302 indicating that the handover will be to the second target BS 308 (step 332). The serving BS 304 also sends a handover confirmation message to the second target BS 308 (step 334).

The MSS 302 sends a handover indication (MOB_HO-IND) message to the serving BS 304 as a final indication that it is about to perform a handover (step 336). If the MSS 302 is going to cancel or reject the handover, the handover indication message will inform the serving BS 304. The handover indication message includes a time parameter (L frames) after which the MSS 302 will initiate the handover. The MSS 302 synchronizes to the second target BS 308 (step 338) and sends a ranging request (RNG-REQ) message to the second target BS 308 to perform initial power leveling and ranging (step 340). The second target BS 308 responds with a ranging response (RNG-RSP) message including information about the MSS's transmit time advance and power adjustments (step 342).

FIG. 3B is a flow diagram of an inter-technology BS initiated handover procedure 350. The procedure 300 utilizes an MSS 352 having an 802.11 part 354 and an 802.16 part 356, a serving BS (BS #1) 358 using 802.16 technology, a first target BS (BS #2) 360 using 802.16 technology, and a second target BS (BS #3) 362 using 802.11 technology. The serving BS 358 sends a neighbor advertisement (MOB_NBR-ADV) message to the 802.16 part 356 of the MSS 352 (step 364). The neighbor advertisement message is used to identify the network and define the characteristics of the neighbor BS to a potential MSS seeking initial network entry or handover. The neighbor advertisement message includes the technology types for each target BS. In the example shown in FIG. 3B, the neighbor advertisement message indicates that there are two neighbor BSs, one using 802.16 technology and the other using 802.11 technology.

The serving BS 358 initiates the handover (step 366) and sends a handover pre-notification message to both target BSs 360, 362 (steps 368, 370). The pre-notification message includes information about the MSS 352, such as the MSS ID, connection parameters, MSS capabilities, BW, and a desired QoS. The serving BS 358 then sends a handover request (MOB_BSHO-REQ) message to the MSS 352 (step 372). The handover request message includes a list of recommended BSs for the MSS 352 to examine and the technology type of each recommended target BS. In FIG. 3B, the handover request message indicates that BS #2 and BS #3 are on the list of recommended BSs.

The MSS 352 initiates a neighbor BS search (step 374), examining each of the BSs recommended by the serving BS 358. While the MSS 352 is performing the neighbor BS search, the serving BS 358 receives handover pre-notification response messages from the first target BS 360 and the second target BS 362 (steps 376, 378). The pre-notification response includes an ACK that the pre-notification message was received and the QoS that the target BS is able to provide. The MSS 352 synchronizes to the first target BS 360 and makes signal level, interference level, and noise level measurements (step 380) and the MSS 352 synchronizes to the second target BS 362 and makes signal level, interference level, and noise level measurements (step 382).

After completing the measurements of the target BSs, the MSS 352 sends a handover response (MOB_MSSHO-RSP) message to the serving BS 358, including the CINR values for each target BS (step 384). The serving BS 358 determines which target BS is better able to serve the MSS 352 by evaluating the capabilities of each target BS against the parameters in the handover pre-notification message. As shown in FIG. 3B, the second target BS 362 is selected because it is able to provide the requested QoS level. The serving BS 358 sends a handover response (MOB_HO-RSP) message to the MSS 352 indicating that the handover will be to the second target BS 362 and will be using 802.11 technology (step 386). The serving BS 358 also sends a handover confirmation message to the second target BS 362 (step 388).

The MSS 352 sends a handover indication (MOB_HO-IND) message to the serving BS 358 as a final indication that it is about to perform a handover (step 390). If the MSS 352 is going to cancel or reject the handover, the handover indication message will inform the serving BS 358. The handover indication message includes a time parameter (L frames) after which the MSS 352 will initiate the handover. The MSS 352 performs a release procedure to release the MSS from the 802.16 technology (step 392). The MSS 352 synchronizes to the second target BS 362 (step 394) and sends a ranging request (RNG-REQ) message to the second target BS 362 to perform initial power leveling and ranging (step 396). The second target BS 362 responds with a ranging response (RNG-RSP) message including information about the MSS's transmit time advance and power adjustments (step 398).

Neighbor Advertisement (MOB NBR-ADV) Message

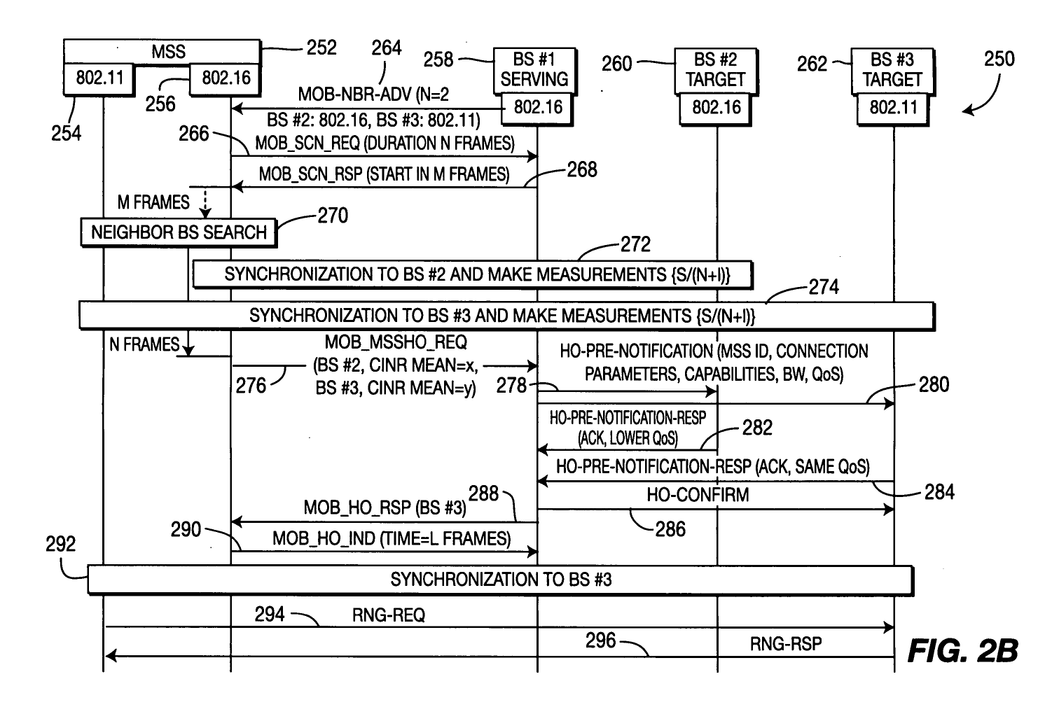

FIG. 4A is a diagram of an existing neighbor advertisement message 400. The message 400 includes a management message type field 402, an operator ID field 404, a number of neighbors field 406, a block of information 408 for each neighbor BS, and a hashed message authentication code (HMAC) Tuple 410. Each neighbor information block 408 includes a neighbor BS ID 412, a DL physical frequency for the neighbor BS 414, a configuration change count field 416, and type-length-value (TLV) encoded neighbor information 418.

The management message type field 402 is used to identify the message as a neighbor advertisement message. The operator ID field 404 includes a unique network ID shared by an association of BSs. The number of neighbors field 406 includes a count of the number of neighbor BSs that are advertising. The HMAC Tuple 410 is used to verify the contents of the message 400.

The neighbor BS ID field 412 contains the unique ID for the neighbor BS. The DL physical frequency field 414 includes the DL center frequency for the neighbor BS. The configuration change count field 416 is incremented whenever any of the values relating to an included data element changes. If the change count 416 is the same as in a previous advertisement message, the MSS can ignore the entire message, since nothing has changed. The TLV encoded neighbor information 418 can include a variable number of parameters, such as downlink channel descriptor (DCD) settings and uplink channel descriptor (UCD) settings.

FIG. 4B is a diagram of a neighbor advertisement message 450 including operational technology information. The message 450 is based on the message 400; the fields 402-418 in the message 450 are the same as in the message 400. The additional information in the message 450 is an operational technology field 452 that is included with each neighbor information block 408. The operational technology field 452 is used to identify the operational technology (e.g., 802.11 or 802.16) for the neighbor BS.

In an alternate embodiment (not shown), the operational technology information can be placed in the TLV encoded neighbor information 418 as a new value and the operational technology field 452 is not needed. For example, the operating technology type can be encoded in one byte as follows:

TABLE 1
TLV Encoded Operating Technology Type

| Byte value | Operating Technology |
|---|---|
| 00000000 | 802.16 |
| 00000001 | 802.11b |
| 00000010 | 802.11g |

Other operational technology types can be similarly encoded.

The neighbor advertisement messages 400, 450 as shown in FIGS. 4A and 4B are periodically sent by the BS. If neighbor BS information is not available, the messages need not be transmitted.

Neighbor Report (MSS NBR-REP) Message

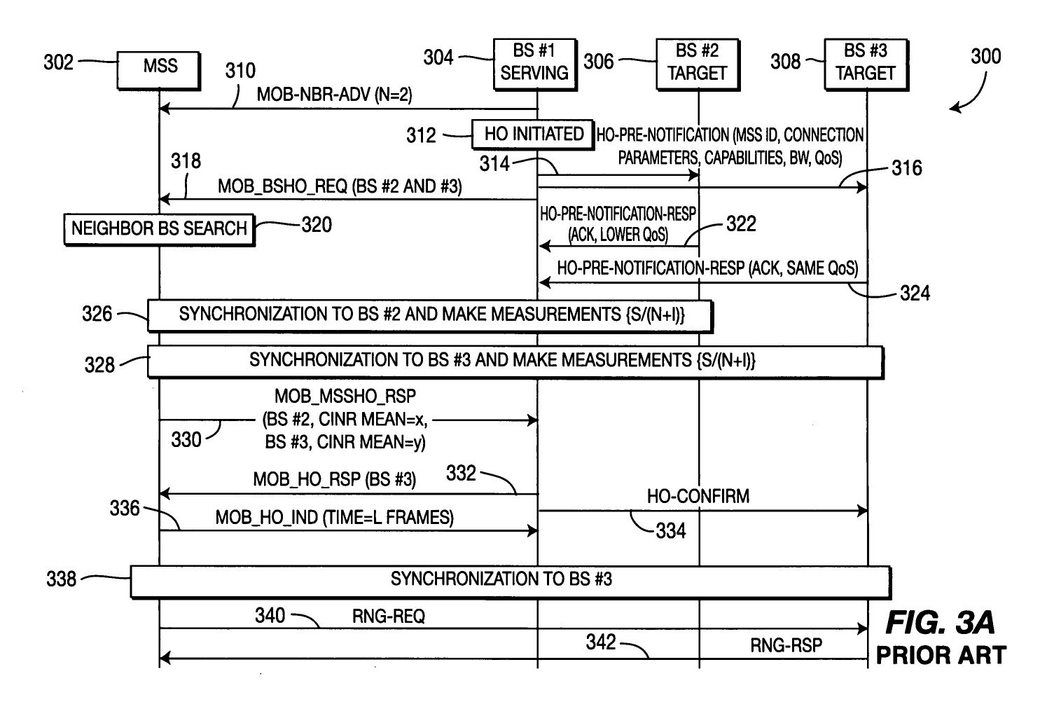

FIG. 5A is a diagram of an existing MSS neighbor report message 500. The message 500 includes a management message type field 502, a number of neighbors field 504, and a block of information 506 for each neighbor BS. Each neighbor information block 506 includes a neighbor BS ID 508, a physical frequency field 510 for the neighbor BS, and TLV encoded neighbor information 512.

The management message type field 502 is used to identify the message as a neighbor report message. The number of neighbors field 504 includes a count of the number of neighbor BSs that are reporting. The neighbor BS ID field 508 contains the unique ID for the neighbor BS. The physical frequency field 510 includes the DL center frequency for the neighbor BS. The TLV encoded neighbor information 512 can include a variable number of parameters, such as DCD settings and UCD settings.

FIG. 5B is a diagram of a MSS neighbor report message 550 including operational technology information. The message 550 is based on the message 500; the fields 502-512 in the message 550 are the same as in the message 500. The additional information in the message 550 is an operational technology field 552 that is included with each neighbor information block 506. The operational technology field 552 is used to identify the operational technology (e.g., 802.11 or 802.16) for the neighbor BS.

The MSS neighbor report messages 500, 550 as shown in FIGS. 5A and 5B are periodically sent by the BS. If neighbor BS information is not available, the messages need not be transmitted.

BS Handover Request (MOB BSHO-REQ) Message

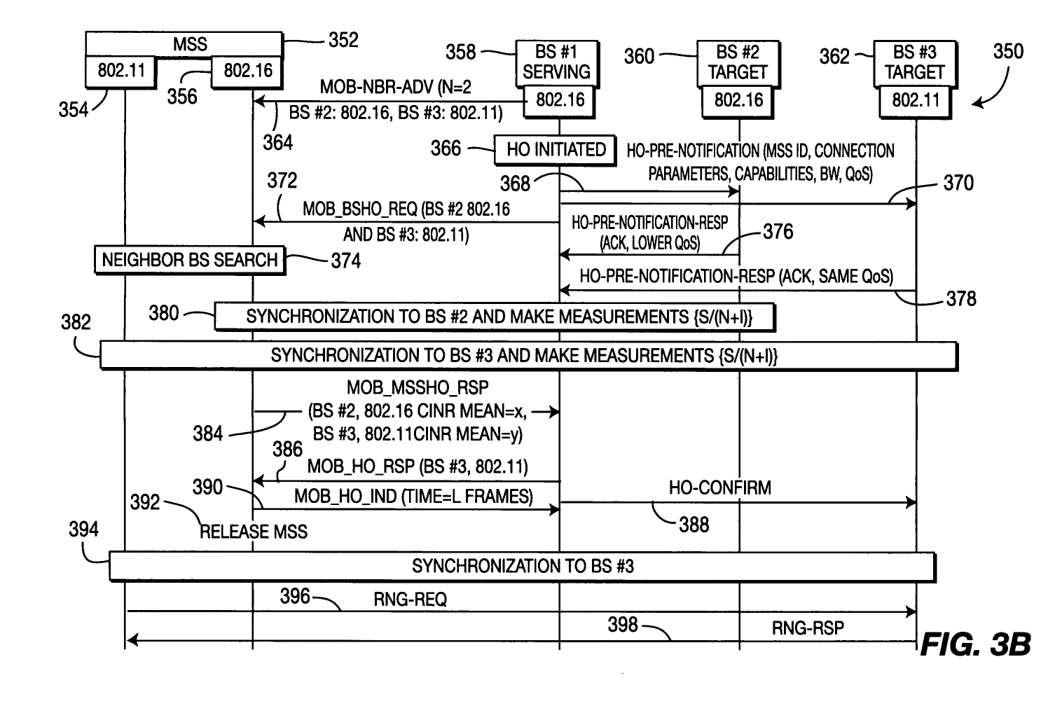

FIG. 6A is a diagram of an existing BS handover request message 600. The message 600 includes a management message type field 602, a network assisted handover supported field 604, a block of information 606 for each neighbor BS, and an HMAC Tuple 608. Each neighbor information block 606 includes a neighbor BS ID 610 and a service level prediction field 612.

The management message type field 602 is used to identify the message as a BS handover request message. The network assisted handover supported field 604 indicates whether the serving BS supports network assisted handover. The HMAC Tuple 608 is used to verify the contents of the message 600. The neighbor BS ID field 610 contains the unique ID for the neighbor BS. The service level prediction field 612 indicates the level of service that the MSS should expect for the neighbor BS. This can include an indication of: no service, some services, full service, or no prediction.

FIG. 6B is a diagram of a BS handover request message 650 including operational technology information. The message 650 is based on the message 600; the fields 602-612 in the message 650 are the same as in the message 600. The additional information in the message 650 is an operational technology field 652 that is included with each neighbor information block 606. The operational technology field 652 is used to identify the operational technology (e.g., 802.11 or 802.16) for the neighbor BS.

The BS handover request messages 600,650 as shown in FIGS. 6A and 6B are sent by the BS to initiate a handover. The MSS scans a list of recommended neighbor BSs (which can include the serving BS) and may select any identified BS without notifying the serving BS.

MSS Handover Request (MOB MSSHO-REQ) Message

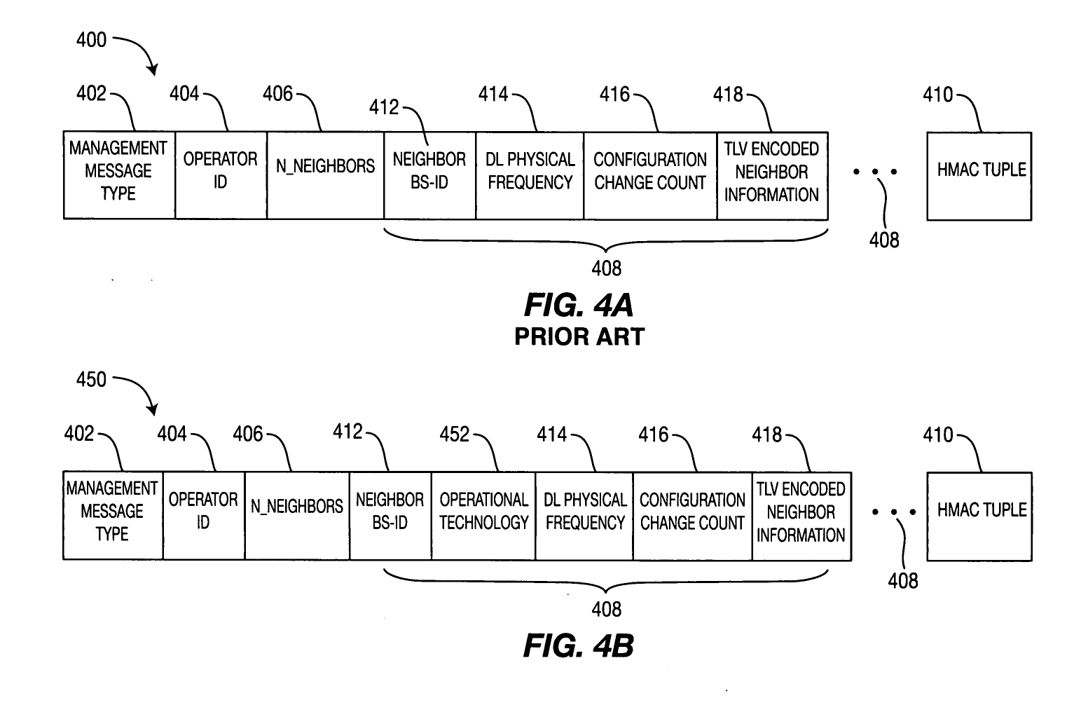

FIG. 7A is a diagram of an existing MSS handover request message 700. The MSS handover request message 700 is sent by the MSS to initiate a handover. The message 700 includes a management message type field 702, a block of information 704 for each neighbor BS, an estimated handover start field 706, and an HMAC Tuple 708. Each neighbor information block 704 includes a neighbor BS ID 710, a BS CINR mean field 712, and a service level prediction field 714.

The management message type field 702 is used to identify the message as a handover request message. The estimated handover start field 706 includes the handover start time (in frames) for the recommended target BS. The HMAC Tuple 708 is used to verify the contents of the message 700. The neighbor BS ID field 710 contains the unique ID for the neighbor BS. The BS CINR mean field 712 indicates the CINR in dB measured at the MSS on the DL signal of a particular BS. The service level prediction field 714 indicates the level of service that the MSS should expect for the neighbor BS. This can include an indication of: no service, some services, full service, or no prediction.

FIG. 7B is a diagram of a MSS handover request message 750 including operational technology information. The message 750 is based on the message 700; the fields 702-714 in the message 750 are the same as in the message 700. The additional information in the message 750 is an operational technology field 752 that is included with each neighbor information block 704. The operational technology field 752 is used to identify the operational technology (e.g., 802.11 or 802.16) for the neighbor BS.

BS Handover Response (MOB BSHO-RSP) Message

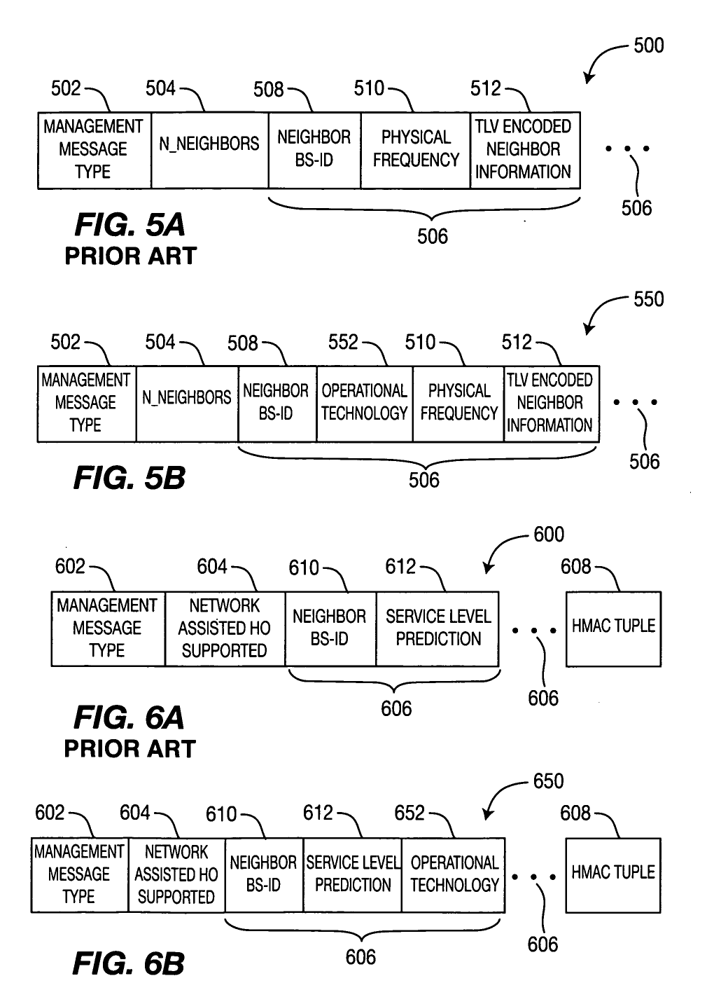

FIG. 8A is a diagram of an existing BS handover response message 800. The BS handover response message 800 is sent to the MSS to respond to a MSS handover request message. The message 800 includes a management message type field 802, an estimated handover start field 804, a block of information 806 for each neighbor BS, and an HMAC Tuple 808. Each neighbor information block 806 includes a neighbor BS ID 810 and a service level prediction field 812.

The management message type field 802 is used to identify the message as a handover response message. The estimated handover start field 804 includes the handover start time (in frames) for the recommended target BS. The HMAC Tuple 808 is used to verify the contents of the message 800. The neighbor BS ID field 810 contains the unique ID for the neighbor BS. The service level prediction field 812 indicates the level of service that the MSS should expect for the neighbor BS. This can include an indication of: no service, some services, full service, or no prediction.

FIG. 8B is a diagram of a BS handover response message 850 including operational technology information. The message 850 is based on the message 800; the fields 802-812 in the message 850 are the same as in the message 800. The additional information in the message 850 is an operational technology field 852 that is included with each neighbor information block 806. The operational technology field 852 is used to identify the operational technology (e.g., 802.11 or 802.16) for the neighbor BS.

Handover Indication (MOB HO-IND) Message

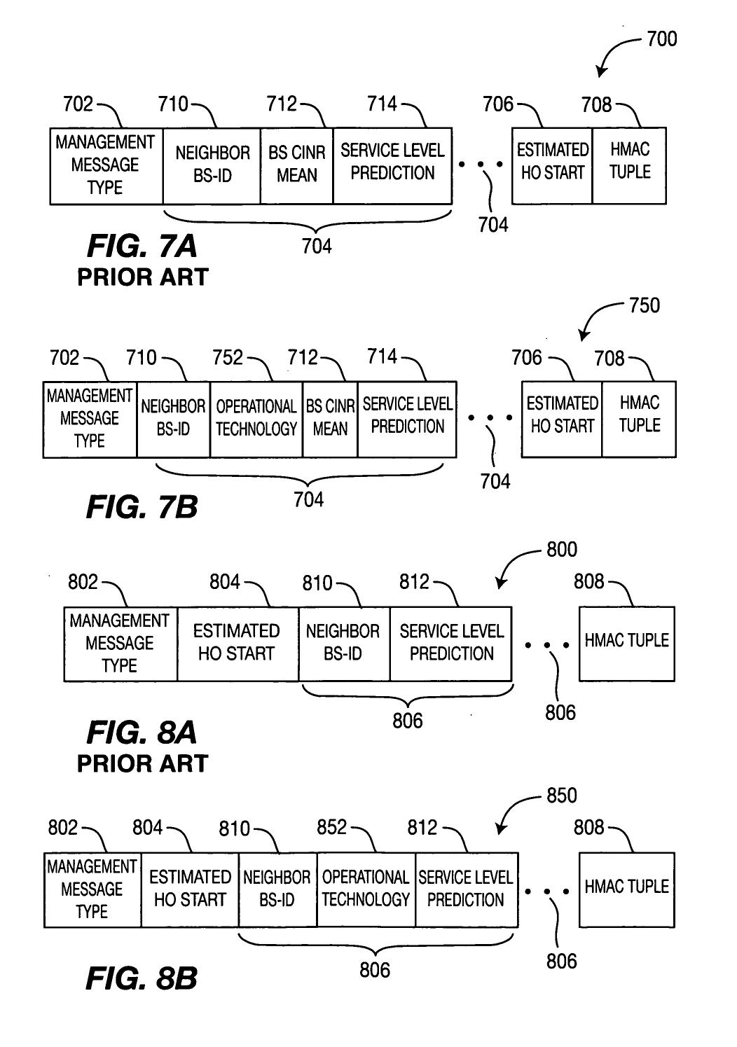

FIG. 9A is a diagram of an existing handover indication message 900. The handover indication message 900 is sent by the MSS for final indication that handover starts, is canceled, or is rejected. The message 900 includes a management message type field 902, a reserved field 904, a handover indication type (HO_IND_type) field 906, a target BS ID field 908, and an HMAC Tuple 910.

The management message type field 902 is used to identify the message as a handover indication message. The handover indication type field 906 provides an indication whether the serving BS will release the MSS, the handover is canceled, or the handover is rejected. The target BS ID field 908 contains the ID of the handover target BS; this field is only used if the handover will be performed. The HMAC Tuple 910 is used to verify the contents of the message 900.

FIG. 9B is a diagram of a handover indication message 950 including operational technology information. The message 950 is based on the message 900; the fields 902-910 in the message 950 are the same as in the message 900. The additional information in the message 950 is an operational technology field 952 that is used to identify the operational technology (e.g., 802.11 or 802.16) for the neighbor BS.

System configured to utilize operational technology information

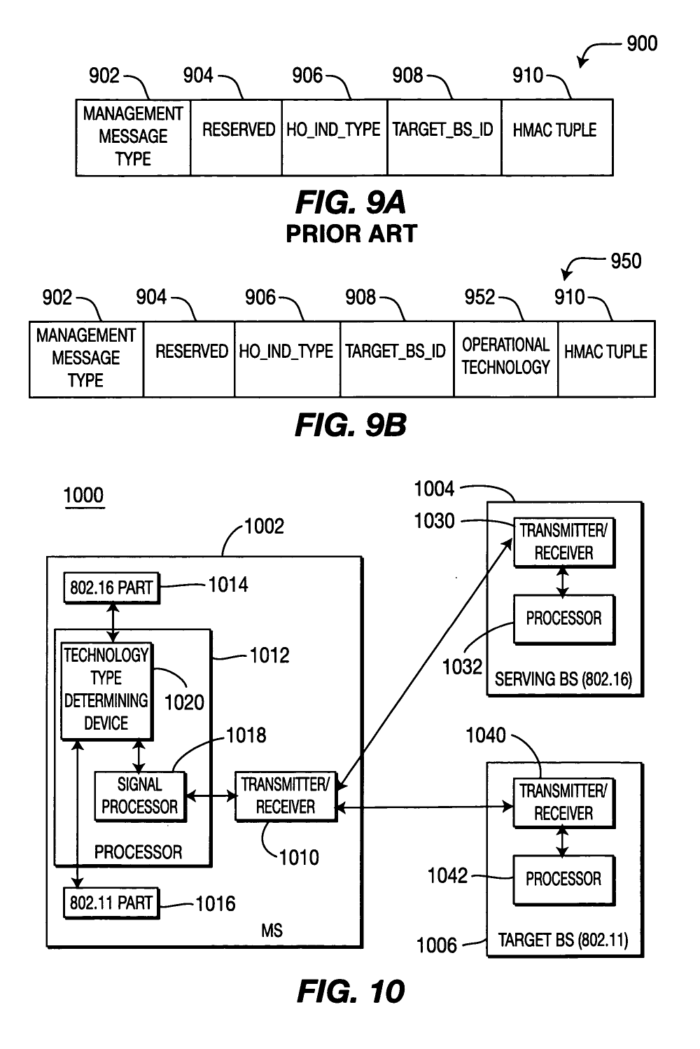

FIG. 10 is a block diagram of a system 1000 configured to utilize the operational technology information field. The system includes a multi-technology capable MS 1002, a serving BS 1004 using 802.16 technology, and a target BS 1006 using 802.11 technology. The MS 1002 includes a transmitter/receiver 1010, a processor 1012, an 802.16 part 1014, and an 802.11 part 1016. The processor 1012 includes a signal processor 1018 and a technology type determining device 1020.

The serving BS 1004 includes a transmitter/receiver 1030 and a processor

The target BS 1006 includes a transmitter/receiver 1040 and a processor 1042.

In operation, the MS 1002 is in communication with the serving BS 1004 using 802.16 technology. The transmitter/receiver 1030 in the serving BS 1004 sends a signal to the MS 1002. The transmitter/receiver 1010 in the MS 1002 receives the signal and passes it to the signal processor 1018. The technology type determining device 1020 is configured to determine which technology (in this example, either 802.16 or 802.11) was used to send the signal to the MS 1002. If the signal is using 802.16 technology, the determining device 1020 forwards the signal to the 802.16 part 1014 for further processing. If the signal is using 802.11 technology, the determining device

1020 forwards the signal to the 802.11 part 1016 for further processing.

For example, when a neighbor advertisement message is sent by the target BS 1006, the processor 1042 includes an operational technology information field in the message, indicating that the target BS uses 802.11 technology. The message is then sent to the MS 1002, where it is forwarded to the 802.11 part 1016 by the determining device 1020. Likewise, when the serving BS 1004 sends a neighbor advertisement message, the processor 1032 includes an operational technology information field in the message, indicating that the serving BS uses 802.16 technology. The message is then sent to the MS 1002, where it is forwarded to the 802.16 part 1014 by the determining device 1020. The determining device 1020 is configured to read the operational technology information field to determine which operating technology is being used.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for performing an inter-technology handover in a wireless communication system in which a mobile subscriber station (MSS) changes base stations (BS), comprising the steps of:
locating one or more target BSs that the MSS can handover to;
identifying the technology used by each target BS;
determining the technology supported by the MSS; and
performing a handover of the MSS to a target BS with which the MSS can communicate.

2. The method according to claim 1, wherein the locating step includes sending an advertisement message by each of the one or more target BSs.

3. The method according to claim 2, wherein the advertisement message includes an operational technology identifier, for identifying the operational technology used by the BS.

4. The method according to claim 1, wherein the identifying step includes transmitting an operational technology identifier by each BS.

5. A method for performing an inter-technology handover in a wireless communication system having a mobile subscriber station (MSS), a serving base station (BS), and one or more target BSs, the method comprising the steps of:
sending a neighbor advertisement message from the serving BS to the MSS, the neighbor advertisement message identifying the one or more target BSs and an operational technology for each BS;
identifying a list of candidate BSs, the candidate BSs selected from the one or more target BSs;
synchronizing the MSS to each of the candidate BSs to determine a signal quality from each BS;
determining a preferred BS for handover; and
performing a handover to the preferred BS.

6. The method according to claim 5, further comprising the steps of:
initiating the handover;
sending a handover pre-notification message from the serving BS to each candidate BS; and
receiving a handover pre-notification response message at the serving BS from each candidate BS.

7. The method according to claim 6, wherein the pre-notification message includes a desired quality of service (QoS) level for the MSS.

8. The method according to claim 7, wherein the pre-notification response message includes a QoS level that the BS can provide.

9. The method according to claim 8, wherein the determining step include selecting a BS that can provide the QoS level desired by the MSS.

10. The method according to claim 6, wherein the initiating step is triggered by the MSS after the synchronizing step.

11. The method according to claim 10, wherein the trigger is the MSS sending a handover request message to the serving BS.

12. The method according to claim 6, wherein the initiating step is triggered by the serving BS before the identifying step.

13. The method according to claim 12, further comprising the step of:
sending a handover request message from the serving BS to the MSS, the handover request message including the list of candidate BSs and the operational technology for each candidate BS.

14. The method according to claim 5, wherein the performing step includes the steps of:
sending a handover response message from the serving BS to the MSS, the handover response message identifying the preferred BS;
sending a handover confirmation message from the serving BS to the preferred BS;
sending a handover indication message from the MSS to the serving BS; and
synchronizing the MSS to the preferred BS.

15. A neighbor advertisement message for use in connection with an inter-technology handover in a wireless communication system including at least one neighboring base station (BS), the message comprising:
a message type field, for identifying the message;
a number of neighbors field, for indicating a number of neighboring BSs;
an information block for each neighbor BS, including:
a neighbor BS identification field;
an operational technology field, for identifying the operational technology of the neighbor BS;
a physical frequency field, for identifying the downlink frequency used by the neighbor BS;
a configuration change count field, for indicating whether any portion of the message has changed; and
a type-length-value encoded neighbor information field, for identifying one or more parameters of the neighbor BS; and
a hashed message authentication code, for verifying the contents of the message.

16. A neighbor report message for use in connection with an inter-technology handover in a wireless communication system including at least one neighboring base station (BS), the message comprising:
a message type field, for identifying the message;
a number of neighbors field, for indicating a number of neighboring BSs; and
an information block for each neighbor BS, including:
a neighbor BS identification field;
an operational technology field, for identifying the operational technology of the neighbor BS;
a physical frequency field, for identifying the downlink frequency used by the neighbor BS; and
a type-length-value encoded neighbor information field, for identifying one or more parameters of the neighbor BS.

17. A base station (BS) initiated handover request message for use in connection with an inter-technology handover in a wireless communication system including a serving BS and at least one neighboring BS, the message comprising:
a message type field, for identifying the message;
a network assisted handover supported field, for identifying whether the serving BS supports network assisted handover;
an information block for each neighbor BS, including:
a neighbor BS identification field;
a service level prediction field, for indicating the level of service provided by the neighbor BS; and
an operational technology field, for identifying the operational technology of the neighbor BS; and
a hashed message authentication code, for verifying the contents of the message.

18. A mobile subscriber station initiated handover request message for use in connection with an inter-technology handover in a wireless communication system including at least one neighboring base station (BS), the message comprising:
a message type field, for identifying the message;
an information block for each neighbor BS, including:
a neighbor BS identification field;
an operational technology field, for identifying the operational technology of the neighbor BS;
a BS carrier to interference plus noise ratio (CINR) mean value field, for identifying a CINR value for the neighbor BS; and
a service level prediction field, for indicating the level of service provided by the neighbor BS;
an estimated handover start field, for identifying the handover start time for the neighbor BS; and
a hashed message authentication code, for verifying the contents of the message.

19. A base station (BS) handover response message for use in connection with an inter-technology handover in a wireless communication system including at least one neighboring BS, the message comprising:
a message type field, for identifying the message;
an estimated handover start field, for identifying the handover start time for the neighbor BS;
an information block for each neighbor BS, including:
a neighbor BS identification field;
an operational technology field, for identifying the operational technology of the neighbor BS; and
a service level prediction field, for indicating the level of service provided by the neighbor BS; and
a hashed message authentication code, for verifying the contents of the message.

20. A handover indication message for use in connection with an inter-technology handover in a wireless communication system including at least one neighboring base station (BS), the message comprising:
a message type field, for identifying the message;
a handover indication type field, for indicating the status of the handover;
a target BS identification field, for identifying the target BS to receive the handover;
an operational technology field, for identifying the operational technology of the neighbor BS; and
a hashed message authentication code, for verifying the contents of the message.

21. A mobile subscriber station (MSS) configured to perform an inter- technology handover from a serving base station (BS) using a first operational technology to a target BS using a second operational technology, the MSS comprising:
a transmitter/receiver;
a processor in communication with said transmitter/receiver, said processor including a technology type determining device;
a first operational technology part in communication with said technology type determining device; and
a second operational technology part in communication with said technology type determining device, said second operational technology part configured to use a different operating technology than said first operational technology part;
wherein said technology type determining device is configured to receive messages from the serving BS and the target BS, said technology type determining device passing the messages to the appropriate operational technology part.

22. The MSS according to claim 21, wherein said processor further includes a signal processor, said signal processor in communication with said transmitter/receiver and said technology type determining device, said signal processor configured to pass messages from said transmitter/receiver to said technology type determining device.
